(19) United States
(12) Patent Application Publication
(10) Pub. No.: US 2004/0211055 A1
(43) Pub. Date: Oct. 28, 2004

(54) Multifunction machine and method of forming control interface

(76) Inventor: Ian William Belchamber, Poole (GB)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/479,805

(22) PCT Filed: Feb. 28, 2002
(86) PCT No.: PCT/GB02/00892

(30) Foreign Application Priority Data
Feb. 28, 2001 (GB) 01 04946.9

(51) Int. Cl. B23P 19/00

(52) U.S. Cl. 29/700

(57) ABSTRACT

A multifunction machine, such as a PCB manufacturing platform, has a plurality of task-specific modules each configured to perform a dedicated task. The machine includes a service interface providing to each of the plurality of task-specific modules a common supply, including power and a communications system backbone. A distributed control system is realized by the communication system backbone associated with the machine and task-specific modules. The task specific drivers co-operate, in use, with the communication system backbone to allow controlled operation of the specified task supported by its respective task-specific module. Through the use of a modular approach, the assembly process can be consolidated into a relatively small physical area of a factory or plant room, with commonly shared equipment further simplifying overall system control and programming.

This invention relates, in general, to a multifunction machine and method of forming a control interface. The invention is particularly, but not exclusively, applicable to machines that place or attach electronic devices onto substrates, dies, printed circuited boards (PCBs) or the like on a potentially repetitive basis.

In the context of multifunction machines and the production of product, such as PCBs in an electronics assembly line, there are usually several individual machines used in succession to produce a finished article. In other words, each machine in the assembly line performs a dedicated and unique function, with each machine containing a specific control interface that requires task-specific programming. Furthermore, when setting up a production process, a control engineer or operative must coordinate operation of the individual machines through generally dissimilar man-machine interfaces (MMIs), with this expending both time and effort and requiring the control engineer or operative to have an intimate knowledge of the different machine interfaces.

It is desirable to reduce capital costs for assembly line equipment in order to improve the profitability of a given manufacturing process. Profitability may also be determined by additional factors, such as overall plant costs including, for example, overall utilisation of working space within a factory or machine shop. Indeed, floor space is a valuable resource in assembly environments and so assembly line planning for optimum performance is important. In any assembly line, the fact that there are generally several complementary machines therefore adds a logistical angle to space planning considerations.

By way of example, in PCB manufacturing, systems contain individual machines dedicated to providing screen printing of solder pastes as well as pick and place machines for automated component placement within the PCB. Both machines may include an X-Y “single roving” camera that cooperates with a control system to use reference fiducials on the PCB to align the PCB for printing or component placement. One example of such an alignment system is illustrated in U.S. Pat. No. 5,752,446, in which a camera is located between the PCB and the print screen to locate the reference points and a control processor is used to make necessary adjustments to the board to align it with the screen prior to printing.

Mechanisms that improve assembly line working and efficiency are therefore clearly desirable.

According to a first aspect of the present invention there is provided a multifunction machine having a plurality of task-specific modules each configured to perform a dedicated assembly task, the assembly machine comprising: a machine base supporting a services interface providing to each of the plurality of task-specific modules a common supply to at least one of: an electrical sub-system; a power supply; a communication system backbone; a pneumatic supply; and a hydraulic supply; a distributed control system realised by the communication system backbone associated with the machine base and task-specific drivers located with each of the task-specific modules, the task specific drivers co-operating, in use, with the communication system backbone to allow controlled operation of the specified task supported by its respective task-specific module.

Preferably, each of the plurality of task-specific modules comprises a frame of module supports defining an area within which is located function specific hardware containing associated task-specific drivers.

The frame of modules supports of each task-specific module preferably interlock in a stacking configuration.

In a preferred embodiment, the plurality of task-specific modules includes a component pick and place module for use in the assembly of PCBs. Preferably the plurality of task specific modules may further comprise a printer module.

An optional feature of this aspect of the present invention may comprise a camera capable of inspecting a PCB after the placing of components thereon.

In another aspect of the present invention there is provided a method of establishing a system control interface in a multifunction machine having a plurality of task-specific modules each configured to perform a dedicated assembly task, the method comprising: having a control processor, arranged to support a basic operating system associated with the machine, interact with a distributed task-specific driver in a task-specific module to produce the system control interface accessible from the base of the assembly machine.

In a further aspect of the present invention there is provided a task-specific assembly module configured to perform a dedicated assembly task in a multifunction machine, the task-specific module comprising: task-specific drivers arranged to co-operate, in use, with a communication system backbone in the assembly machine to produce a control system having responsibility for controlled operation of the task-specific assembly module; and a services interface providing a connection of the task-specific module to a common supply in the assembly machine, the services interface and common supply providing at least one of: an electrical sub-system; a power supply; the communication system backbone; a pneumatic supply; and a hydraulic supply.

Advantageously, the present invention reduces overall space required in an assembly line manufacturing environment by collocating modular machine sub-systems that share a common control interface. By employing a modular design, mechanical and electrical systems commonly employed in different assembly stages can be shared to reduce overall system cost. The common control interface simplifies and reduces machine programming since use of a generic interface relieves the likelihood of error during programming by providing a reduced instruction set, preferably based on a graphic user interface (GUI). Additional machine sub-systems preferably share a common electrical interface supporting, for example, motor power, signal power, communication and, as needed, pneumatic or hydraulic supplies. Furthermore, use of the modular machine of the present invention may statistically benefit from reduced assembly line downtime as a consequence of reduced electrical and mechanical part count. For example, a reduction in the number of power supplies, computers, conveyors, motors, electrical connectors, reduces the overall probability of the machine failing, thereby minimising downtime for the whole process.

In another aspect of the present invention there is provided a PCB assembly machine comprising a solder paste printing device and a pick and place device mounted on a single machine base so as to permit a PCB to be processed in series by the printing device and pick and place device, the machine having a central control system. Preferably the printing device may be mounted above the pick and place device.

In an optional feature of this aspect of the present invention the devices may be modular.

Exemplary embodiments of the present invention will now be described with reference to the accompanying drawings, in which:

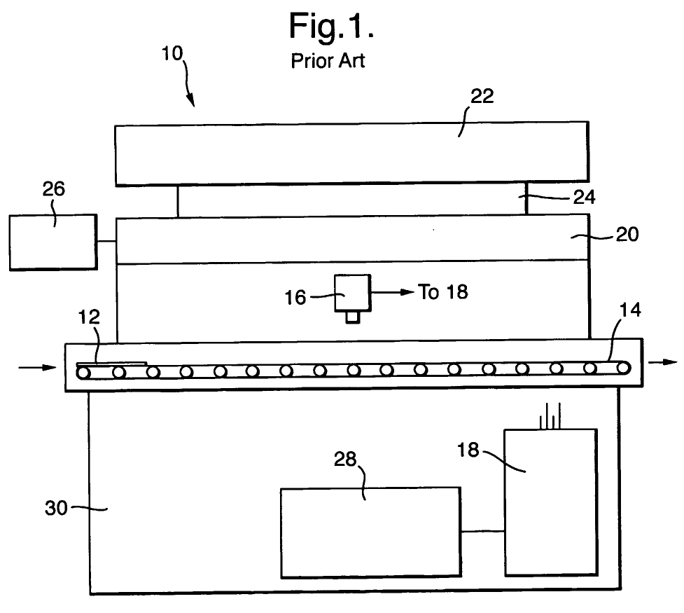

FIG. 1 is a schematic block diagram of a conventional solder paste printer;

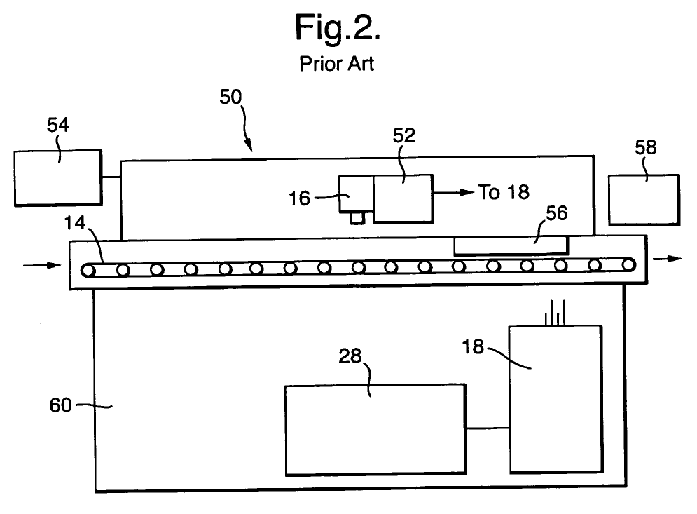

FIG. 2 is a schematic block diagram of a conventional pick and place machine in a PCB assembly line;

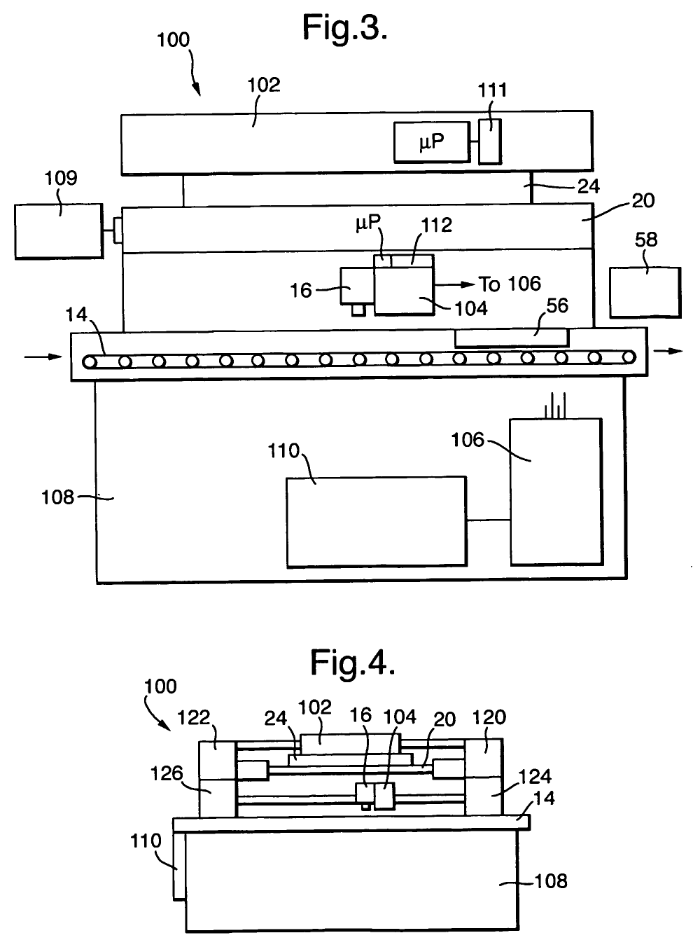

FIG. 3 is a schematic representation of a modular machine of one embodiment of the present invention;

FIG. 4 is an end view of the machine of FIG. 3 showing layered machine modules; and

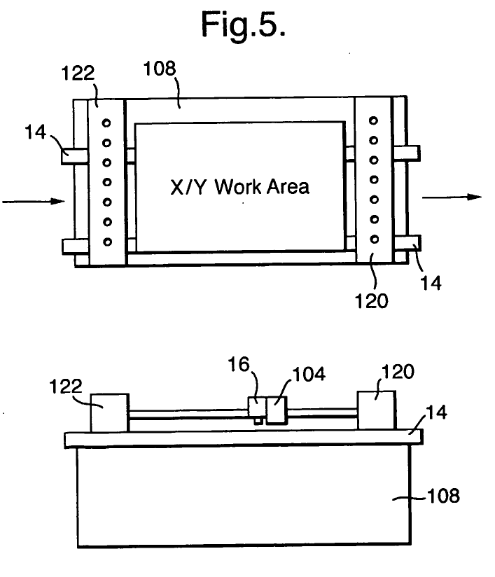

FIG. 5 is a plan view of a machine module and support frame of FIGS. 3 and 4.

Reference is first made to FIG. 1 which is a schematic block diagram of a conventional solder paste printer 10. As is common in existing technology, a PCB 12 or the like is moved by a product transport system 14, such as a conveyor, into a body of the solder paste printer 10. In other classes of embodiment, manual or shuttle table transport systems may be employed.

The PCB 12 is held firmly within the confines of a suitable frame before being scanned by a camera 16 that, in collaboration with a controller 18, measures and identifies the fiducial positions. Under the control of the controller 18, an alignment is made between the PCB 12 and a print stencil 20, the alignment accomplished by varying the relative position of the stencil and PCB in x and y directions and rotation in the x y plane about the z axis perpendicular to x and y (theta). For the purposes of this application, the x direction is parallel to the PCB feed direction machine and the y direction is transverse to the PCB feed direction.

The camera 16 is then moved out of the way (under the control of the controller 18) in order to allow the PCB to be moved up against the underside of the print stencil 20. Generally, the PCB is moved through a vertical space previously occupied by the camera 16. A print head 22 is then able to print the PCB 12 through the print stencil 20, with a squeegee/pumphead system 24 operational to print solder paste, photoresist or the like. When printing is complete, the PCB 12 is moved away from the print stencil and, eventually, out of the solder paste printer 10 on the product transport system 14.

A print system interface 26 provides an MMI to allow selection of programming features and options implemented by the controller 18. Generally, power, pneumatic feed and distribution sub-systems 28 are associated with, and preferably located within the body or machine base 30. The basic architecture could, of course, be improved through the inclusion of, for example, an underside stencil cleaner beneath the print stencil 20 and a solder paste dispenser above the print stencil 20, as will readily be appreciated. The underside stencil cleaner (not shown) would typically be operationally responsive to the controller 18. From purely an inspection perspective, the solder paste printer 10 is inherently equipped to perform this function through the existence of the camera 16, controller 18 and product transport system 14. In this respect, as will be understood, images from the camera are essentially subjected to computer analysis.

Turning now to FIG. 2, there is shown a schematic block diagram of a conventional pick and place machine 50 in an exemplary PCB assembly line environment. The pick and place machine comprises a pick and place robot 52 and camera 16 mounted on a machine base 60 with a product transfer system 14 therebetween as is known. The pick and place robot 52 is operationally responsive to control inputs provided by the controller 18 based on image data provided by the camera 16. The pick and place machine 50 has a distinct system interface (MMI) 54 that may operate from a different operating system to the print system interface 26 of FIG. 1. The pick and place robot 52 is typically juxtaposed the camera 16.

The pick and place system may also include a component camera 56 which may be on the base (as shown) or on the robot and that interacts with the pick and place robot to scan, authenticate and/or align a selected pick and place component prior to placement in the PCB or the like. Again, power, pneumatic feed and distribution sub-systems 28 are preferably located within the body or machine base 60.

From an operational perspective, the pick and place procedure operates thus: a PCB is passed into the middle of the conveyor, then firmly held. The camera 16 passes over the PCB in X and Y directions to allow the controller 18 to image and measure the fiducial points on the PCB. The pick and place robot moves between component feeder areas 58 (typically located toward the front and rear (and possibly sides) of the machine 60) and the PCB in order to acquire and to place the components. When placing is complete, the PCB is moved out of the machine 50.

Having regard to FIGS. 3 and 4, there is shown a schematic representation of a modular machine of a preferred embodiment of the present invention. In accordance with the principles of the present invention, task-specific functional equipment is modularised on a task-specific platform basis, whereas common control circuitry and electrical, pneumatic and/or hydraulic sub-systems are shared.

With respect to the product transport system 14, print stencil 20, squeegee/pumphead 24 and the component camera 56, these generally correspond to architectures implemented in the prior art and are mounted on machine base 108. As regards a print head 102 and pick and place robot 104, the preferred embodiment of the present invention utilises an intelligent distributed control system in which print head and pick and place drivers are located within the respective components, e.g. within local hardware and processor-accessible cache 111, 112.

In this way, an overall system controller 106 can interface with a general MMI 109 (preferably presenting a GUI) to provide an operational control platform, while function-specific code is accessed by the controller (and presented to the MMI 109) from an appropriate interfaced cache local to the appropriate hardware. Furthermore, a common services interface that serves all modules can be reduced to a low cost services connector interface 110 into which each module is plugged-in, with the services connector interface 110 providing motor power, signal power, communication and, as required, pneumatic or hydraulic supplies (irrespective of numbers of sensors or motors within each task-specific module). The service connector interface 110 therefore lends itself to machine upgrade capabilities in which the machine's functionality is enhanced by the addition of an extra module, which upgrade may be completed in a field environment.

The distributed control system of the preferred embodiment therefore eliminates the need for large number of specific looms to various motors and sensors within a machine. The electrical, pneumatic and/or hydraulic systems common between modules are supported from shared hardware preferably located within the machine base 108.

With the common control interface (MMI 109) preferably PC-based, the controller 106 interrogates the local caches to determine a configuration setting; the mechanism by which this is accomplished will be readily appreciated by the skilled addressee. In accordance with a preferred embodiment, all modules are based around a common GUI, although specific control functions are detailed in the local cache 111, 112. In other words, the basic software control system operates to present a common control screen that, for example, provides:

User logon information and permission levels;

Product information such as: PCB size, component/tooling locations, step/repeat information and fiducials;

User/machine/event logging and related analysis;

Offline programming;

Machine setup and diagnostics; and

Line interfacing (including transfer signals, line control software).

In the exemplary embodiment of a PCB print and component place machine 100 of FIGS. 3 and 4, the placing sequence must clearly follow the print sequence. Inspection can, on the other hand, occur at any time, e.g. after either or both operations.

In relation to the mechanics of each module, this can best be appreciated with reference to FIGS. 4 and 5. Each module (of which there are two shown in FIG. 4) is preferably assembled as a layer supported within a frame of module supports 120-126. The function specific hardware, e.g. camera 16 and pick and place robot 104 and associated services hardware, is then positioned within the frame in this embodiment. The modules are then interlocked together, such as with complementary pins and holes respectively protruding from, or drilled within, the module supports 120-126. Of course, any appropriate coupling between adjacently stacked support modules 120-126 would be acceptable.

In a preferred embodiment, each module includes a module support at either end, e.g. to support a transverse camera front/rear drive. Task specific hardware (including associated control drivers) is located within the space defined by the module supports 120-126; this ensures that additional module layers do not physically interfere with pre-existing module layers.

In an alternative embodiment, the pick and place and printing devices may be mounted onto a single machine base in a non-modular way, thereby enabling a PCB to be processed in series by the printing device and pick and place device. The machine has the advantage of a single central control system for both devices and thus still has the benefit of capital cost savings and reduced downtime throughout its working life. As in the above described modular embodiment, the printing device may advantageously be mounted above the pick and place device.

It will, of course, be appreciated that the above description has been given by way of example only and that modifications in detail may be made within the scope of the present invention. For example, while the preferred embodiment of the present invention has been described in the context of a PCB manufacturing assembly, it will be understood that the technique of modularisation is generally applicable to all similar production-line machines. Consequently, the exemplary embodiment to PCB manufacturing techniques and architectures should not be considered limiting, but merely exemplary of the modularisation technique. Furthermore, it will be appreciated that other modular systems may be employed. For example, modules such as the print head and pick and place may be placed side by side on the same frame, or on different frames but using the same distributed control system and user interface. Additionally, whilst the invention has been described with reference to fully inline machines, it is envisaged that it could be adapted for a wide variety of machine types including fully manual standalone machines.

1. A machine for mounting electronic components onto a printed circuit board (pcb), the machine comprising:
a machine base having a structure for supporting a machine services interface for coupling to services supplies:
a pick and place arrangement supported by the structure and being coupled to the machine services interface, the pick and place arrangement being for picking an electronic component from an electrical component supply and placing the electronic component at a predetermined location on a pcb;
an imaging arrangement including a camera, the imaging arrangement being supported by the structure and being coupled to the machine services interface and being utilizable for imaging of the pcb to provide at least one of alignment and inspection operations; and
wherein the machine services interface includes at least a power supply interface for coupling to a power supply and a control system interface, the control system interface including a user interface for enabling the arrangements of the operation of the machine to be controlled by a user.

2. A machine for mounting electronic components onto a pcb according to claim 1, the machine including a solder paste printing arrangement supported by the structure and being coupled to the machine services interface, the solder paste printing arrangement being for printing solder paste onto the pcb through a stencil providing a printing pattern prior to the pick and place arrangement placing an electronic component on the pcb.

3. A machine for mounting electronic components onto a pcb according to claim 1, wherein the structure is integral with the machine base.

4. A machine for mounting electronic components onto a pcb according to claim 2, wherein the structure includes a plurality of levels.

5. A machine for mounting electronic components onto a pcb according to claim 4, wherein the solder paste printing arrangement is supported by the structure at a first of the levels.

6. A machine for mounting electronic components onto a pcb according to claim 5, wherein the pick and place arrangement is supported by the structure at a second of the levels.

7. A machine for mounting electronic components onto a pcb according to claim 6, wherein the first level is located above the second level in the structure.

8. A machine for mounting electronic components onto a pcb according to claim 4, wherein the imaging arrangement is supported by the structure at any of the levels.

9. A machine for mounting electronic components onto a pcb according to claim 1, wherein the imaging arrangement is further utilizable for inspecting a pcb after electronic components have been placed thereon.

10. A machine for mounting electronic components onto a pcb according to claim 1, wherein the structure is located above the machine base.

11. A machine for mounting electronic components onto a pcb according to claim 1, wherein there is a single work area in the machine at which a pcb can be operated on by all the arrangements.

12. A machine for mounting electronic components onto a pcb according to claim 10, wherein the imaging arrangement is utilizable for inspecting a pcb before it is transported away from the work area.

13. A machine for mounting electronic components onto a pcb according to claim 1, wherein the machine services interface further includes at least one of:
an electrical subsystem interface;
a pneumatic supply interface; and
a hydraulic supply interface.

14. A machine for mounting electronic components onto a pcb according to claim 2, wherein the solder paste printing arrangement includes means for controlling the imaging arrangement for imaging the pcb when it is in a work area for aligning a stencil in the solder paste printing arrangement accurately with the pcb.

15. A machine for mounting electronic components onto a pcb according to claim 14, the machine including a product transport system for moving the work area towards the solder paste printing arrangement so that, in use, a pcb located in the work area is moved against a stencil in the solder paste printing arrangement so that a print head can print a predetermined material through the stencil onto the pcb.

16. A machine for mounting electronic components onto a pcb according to claim 15, wherein the predetermined material comprises of a material selected from the group consisting of solder paste, photoresist and solder.

17. A machine for mounting electronic components onto a pcb according to claim 1, wherein the pick and place arrangement includes controller for controlling the imaging arrangement for imaging the pcb when it is in a work area for enabling a pick and place robot to locate accurately an electronic component onto the pcb.

18. A machine for mounting electronic components onto a pcb according to claim 1, wherein the user interface comprises a single user interface for enabling all the operations of the arrangements to be controlled by a user.

19. A machine for mounting electronic components onto a pcb according to claim 18, wherein the user interface comprises a single graphic user interface (GUI) for enabling the operation of the arrangements to be controlled by a user.

20. A machine for mounting electronic components onto a pcb according to claim 1, wherein the control system interface includes an interface for coupling to a computer control system.

21. A machine for mounting electronic components onto a pcb according to claim 1, wherein the inspection operation is selected from the group consisting of i) inspection of the entire pcb before any electronic components are mounted; ii) inspection of a portion of the pcb before an electronic component is mounted; iii) inspection of a portion of the pcb after an electronic component has been mounted; iv) inspection of the entire pcb after all electronic components have been mounted; and v) inspection of the electronic component supply.

22. A machine for mounting electronic components onto a pcb according to claim 1, wherein the machine includes a transport mechanism for transporting the pcb to and from a work area at which the pcb can be operated on by at least the pick and place arrangement, when the machine is in use.

23. A machine for mounting electronic components onto a printed circuit board (pcb), the machine comprising:
a machine base having a structure for supporting a machine services interface for coupling to services supplies:
a pick and place arrangement supported by the structure and being coupled to the machine services interface, the pick and place arrangement being for picking an electronic component from an electrical component supply and placing the electronic component at a predetermined location on a pcb; and
a solder paste printing arrangement supported by the structure and being coupled to the machine services interface, the solder paste printing arrangement being for printing solder paste onto the pcb through a stencil providing a printing pattern prior to the pick and place arrangement placing an electronic component on the pcb;
wherein the machine services interface includes at least a power supply interface for coupling to a power supply and a control system interface, the control system interface including a user interface for enabling the arrangements of the operation of the machine to be controlled by a user.

24. A machine for mounting electronic components onto a pcb according to claim 23, wherein the structure includes a plurality of levels.

25. A machine for mounting electronic components onto a pcb according to claim 24, wherein the solder paste printing arrangement is supported by the structure at a first of the levels.

26. A machine for mounting electronic components onto pcb according to claim 25, wherein the pick and place arrangement is supported by the structure at a second of the levels.

27. A machine for mounting electronic components onto a pcb according to claim 23, wherein there is a single work area in the machine at which a pcb can be operated on by all the arrangements.

28. A machine for mounting electronic components onto a pcb according to claim 23, the machine including a product transport system for moving the work area towards the solder paste printing arrangement so that, in use, a pcb located in the work area is moved against a stencil in the solder paste printing arrangement so that a print head can print a predetermined material through the stencil onto the pcb.

29. A machine for mounting electronic components onto a pcb according to claim 28, wherein the predetermined material is selected from the group consisting of solder paste, photoresist and solder.

30. A machine for mounting electronic components onto a pcb according to claim 23, wherein the machine includes a transport mechanism for transporting the pcb to and from a work area at which the pcb can be operated on by at least the pick and place arrangement, when the machine is in use.

31. A machine for mounting electronic components onto a printed circuit board (pcb), the machine comprising:
a machine base having a structure for supporting a machine services interface for coupling to services supplies:
a pick and place arrangement supported by the structure and being coupled to the machine services interface, the pick and place arrangement being for picking an electronic component from an electrical component supply and placing the electronic component at a predetermined location on a pcb;
a solder paste printing arrangement supported by the structure and being coupled to the machine services interface, the solder paste printing arrangement being for printing solder paste onto the pcb through a stencil providing a printing pattern prior to the pick and place arrangement placing an electronic component on the pcb; and
an imaging arrangement including a camera, the imaging arrangement being supported by the structure and being utilizable for imaging of the pcb to provide at least one of alignment and inspection operations:
wherein the machine services interface includes at least a power supply interface for coupling to a power supply and a control system interface, the control system interface including a user interface for enabling the arrangements of the operation of the machine to be controlled by a user.

32. A machine for mounting electronic components onto a pcb according to claim 31, wherein the structure includes a plurality of levels.

33. A machine for mounting electronic components onto a pcb according to claim 32, wherein the solder paste printing arrangement is supported by the structure at a first of the levels.

34. A machine for mounting electronic components onto a pcb according to claim 33, wherein the pick and place arrangement is supported by the structure at a second of the levels.

35. A machine for mounting electronic components onto a pcb according to claim 32, wherein the imaging arrangement is supported by the structure at any of the levels.

36. A machine for mounting electronic components onto a pcb according to claim 31, wherein the imaging arrangement is further utilizable for inspecting a pcb after electronic components have been placed thereon.

37. A machine for mounting electronic components onto a pcb according to claim 31, wherein there is a single work area in the machine at which a pcb can be operated on by all the arrangements.

38. A machine for mounting electronic components onto a pcb according to claim 37, wherein the imaging arrangement is utilizable for inspecting a pcb before it is transported away from the work area.

39. A machine for mounting electronic components onto a pcb according to claim 31, wherein the solder paste printing arrangement includes means for controlling the imaging arrangement for imaging the pcb when it is in a work area for aligning a stencil in the solder paste printing arrangement accurately with the pcb.

40. A machine for mounting electronic components onto a pcb according to claim 39, the machine including a product transport system for moving the work area towards the solder paste printing arrangement so that, in use, a pcb located in the work area is moved against a stencil in the solder paste printing arrangement so that a print head can print a predetermined material through the stencil onto the pcb.

41. A machine for mounting electronic components onto a pcb according to claim 31, wherein the pick and place arrangement includes a controller for controlling the imaging arrangement for imaging the pcb when it is in a work area for enabling a pick and place robot to locate accurately an electronic component onto the pcb.

42. A machine for mounting electronic components onto a pcb according to claim 31, wherein the inspection operation is selected from the group consisting of i) inspection of the entire pcb before any electronic components are mounted; ii) inspection of a specific portion of the pcb before an electronic component is mounted; iii) inspection of a portion of the pcb after a specific electronic component has been mounted; iv) inspection of the entire pcb after all components have been mounted; and v) inspection of the electronic component supply.

43. A machine for mounting electronic components onto a pcb according to claim 31, wherein the machine includes a transport mechanism for transporting the pcb to and from a work area at which the pcb can be operated on by at least the pick and place arrangement, when the machine is in use.
